(19) United States
(12) Patent Application Publication
(10) Pub. No.: US 2005/0188327 A1
(43) Pub. Date: Aug. 25, 2005

(54) On screen display device and a message displaying method thereof

(76) Inventor: Chi-Pao Huang, Yangmei Township (TW)

Correspondence Address: RABIN & Berdo, PC, 1101 14TH STREET, NW, SUITE 500, WASHINGTON, DC, 20005, US

(21) Appl. No.: 11/057,157

(22) Filed: Feb. 15, 2005

(30) Foreign Application Priority Data
Feb. 19, 2004 (TW) 93104159

(51) Int. Cl. G06F 3/00; G06F 17/24

(52) U.S. Cl. 715/788; 715/513; 715/501.1; 715/517; 715/782

(57) ABSTRACT

An on screen display (OSD) device and the message displaying method thereof are provided. The OSD device includes an operating interface, a display unit and a storage unit. The display unit, which is used for displaying a screen-adjustment window having a message option when the operating interface is pressed, displays a message window having a message-editing item for editing a message when the message option is selected via the operating interface. The store unit is for storing the message. The message will be displayed on the display unit when selected via the operating interface.

This application claims the benefit of Taiwan application Serial No. 93104159, filed Feb. 19, 2004, the subject matter of which is incorporated herein by reference.

### BACKGROUND OF THE INVENTION

1. Field of the Invention

The invention relates in general to a display and a display method, and more particularly to an on screen display (OSD) device and a message displaying method.

2. Description of the Related Art

With the rapid advance in science and technology, display has become an indispensable device to modern people's everyday life. The display may be a cathode ray tube (CRT) screen or a plane display. The CRT screen is an analog display, while the plane display is a digital display such as a liquid crystal display (LCD) or an organic light emitting diode (OLED) display. Owing to the advantages of slimness, compactness, low radiation and better resolution, the plane display has gradually taken the market share from the CRT screen and become modern people's most favorite display.

When adjusting the frame of a display, the user used to use the button disposed at the lower part of the casing of the display to adjust frame parameters such as brightness, contrast, and vertical/horizontal width and position. Along with the advance in the technology of adjusting display frame, an OSD device with on screen display (OSD) function and more frame adjusting parameters, such as vertical/horizontal waves, horizontal distortion, rotation, color, zooming and demagnetization, has already been developed.

When the user presses a function key disposed at the lower part of the OSD device, the OSD device will display a corresponding frame adjusting window containing a plurality of frame adjusting parameters. Next, when the user uses a select key disposed at the lower part of the OSD device to select needed frame adjusting parameter, the user can adjust the frame adjusting parameter via a direction key disposed at the lower part of the OSD device. It is noteworthy that when the OSD device is coupled to the computer, the OSD function is supported by the OSD device directly and is not driven by the drive routine of operating system of the computer. Therefore, the user can use the OSD function of OSD device no matter the computer is switched on or switched off.

It is noteworthy that the OSD function of a conventional OSD device has been set fixed, so the user can adjust only a few frame adjusting parameters, which do not suffice for editing purpose. For example, if the user would like to leave his/her seat, the user normally puts the message on an adhesive paper and has it adhered onto the OSD device. However, after the adhesive paper is removed, dusts might easily get alighted on the residual glue left on the OSD device, affecting the appearance of the OSD device greatly. On the other hand, the user can use the computer's screen protection routine to leave message on the frame of the OSD device only when the computer is switched on; however, once the computer is switched off, the user would not be able to leave a message on the frame of the OSD device.

### SUMMARY OF THE INVENTION

It is therefore an object of the invention to provide an on screen display (OSD) device and a message displaying method thereof. The extra design of having a message board item allows the user to edit and select a message and have the selected message displayed on the OSD device, enabling the OSD device to display the message even when the computer is switched off and the screen protection routine is not available, and greatly enhancing the practicality of the OSD device.

The invention achieves the above-identified object by providing an OSD device, which includes an operating interface, a display unit, and a storage unit. The display unit is for displaying a frame adjusting window when the operating interface is pressed, wherein the frame adjusting window includes a message board item. The display unit will display a message board window when message board item is selected via the operating interface. The message board window includes a message editing item for editing a message, while the storage unit is for storing the message. When the message is selected via the operating interface, the display unit will display the message.

The invention achieves the above-identified object by further providing an OSD device, which includes an operating interface, a display unit, and a storage unit. The display unit is for displaying a frame adjusting window when the operating interface is pressed, wherein the frame adjusting window includes a message board item. The display unit will display a message board window when the message board item is selected via the operating interface. The message board window includes at least a default message, while storage unit for storing the default message. When the default message is selected via the operating interface, the display unit displays the default message.

The invention achieves the above-identified object by providing a message displaying method. In the method, firstly, open a frame adjusting window having a message board item. Next, select the message board item and accordingly display a message board window including a message editing item. After that, select the message editing item, and edit a message. Next, store the message. After that, select and display the message.

The invention achieves the above-identified object by further providing a message displaying method. In the method, firstly, open a frame adjusting window having a message board item. Next, select message board item and accordingly display a message board window including at least a default message. After that, select and display the default message.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a circuit diagram of an OSD device according to a preferred embodiment of the invention;

FIG. 1B is a structural front view of an OSD device according to a preferred embodiment of the invention;

FIG. 2 is a diagram showing the status of the display unit in FIG. 1B when the display unit displays a frame adjusting window;

FIG. 3 is a diagram showing the status of the display unit in FIG. 1B when the display unit displays a message board window;

FIG. 4 is a diagram showing the status of the display unit in FIG. 1B when the display unit displays a message editing frame;

FIG. 5 is a diagram showing the status of the display unit in FIG. 1B when the display unit displays message selecting frame;

FIG. 6 is a diagram showing the status of the display unit in FIG. 1B when the display unit displays a message;

FIG. 7 is a diagram showing the status of the display unit in FIG. 1B when the display unit displays a default message;

FIG. 8 is a flowchart for a message displaying method according to a preferred embodiment of the invention; and

FIG. 9 is a flowchart for another message displaying method according to a preferred embodiment of the invention.

### DETAILED DESCRIPTION OF THE INVENTION

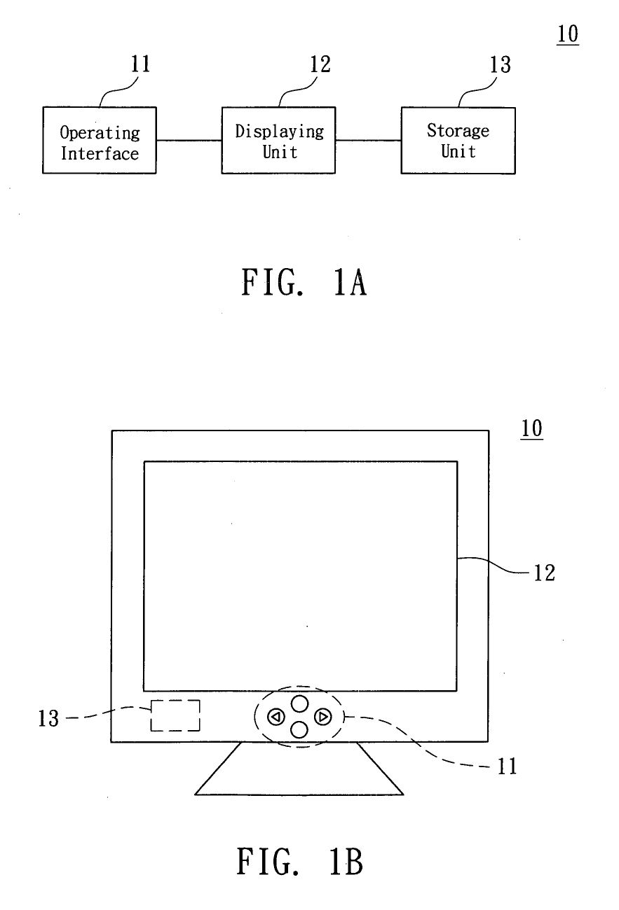

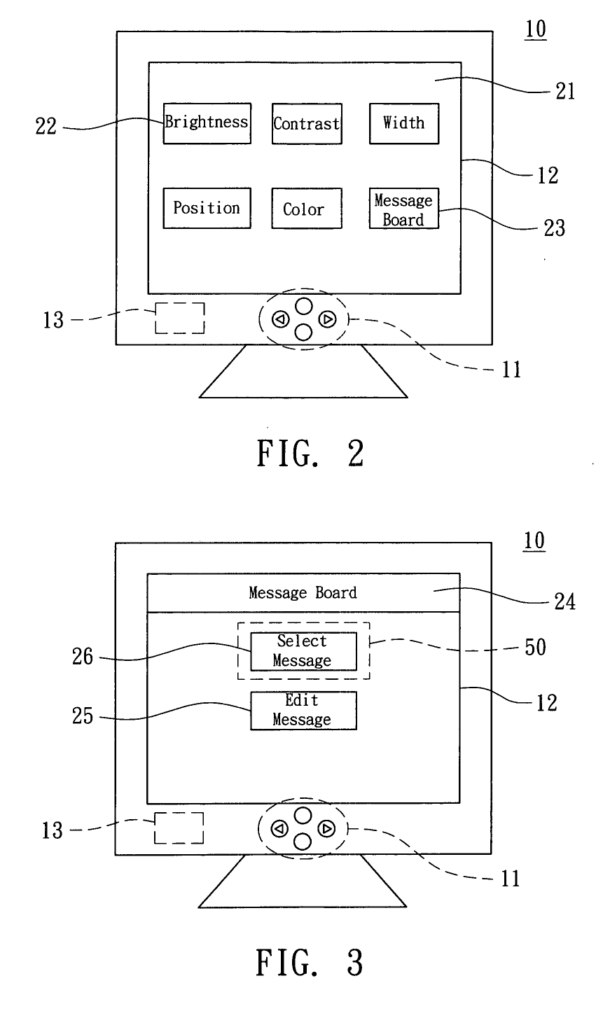

Referring to FIG. 1A and FIG. 1B, FIG. 1A is a circuit diagram of an on screen display (OSD) device according to a preferred embodiment of the invention, and FIG. 1B is a structural front view of an OSD device according to a preferred embodiment of the invention. In FIG. 1A and FIG. 1B, OSD device 10 at least includes an operating interface 11, a display unit 12, and a storage unit 13. The operating interface 11 at least includes a function key, a select key, and a direction key. When a user presses the operating interface 11, the display unit 12 will display a frame adjusting window 21 as shown in FIG. 2. In FIG. 2, the frame adjusting window 21 includes a plurality of frame adjusting parameters 22 and a message board item 23, wherein the frame adjusting parameter 22 at least includes frame adjusting parameters of brightness, contrast, and vertical/horizontal width and position.

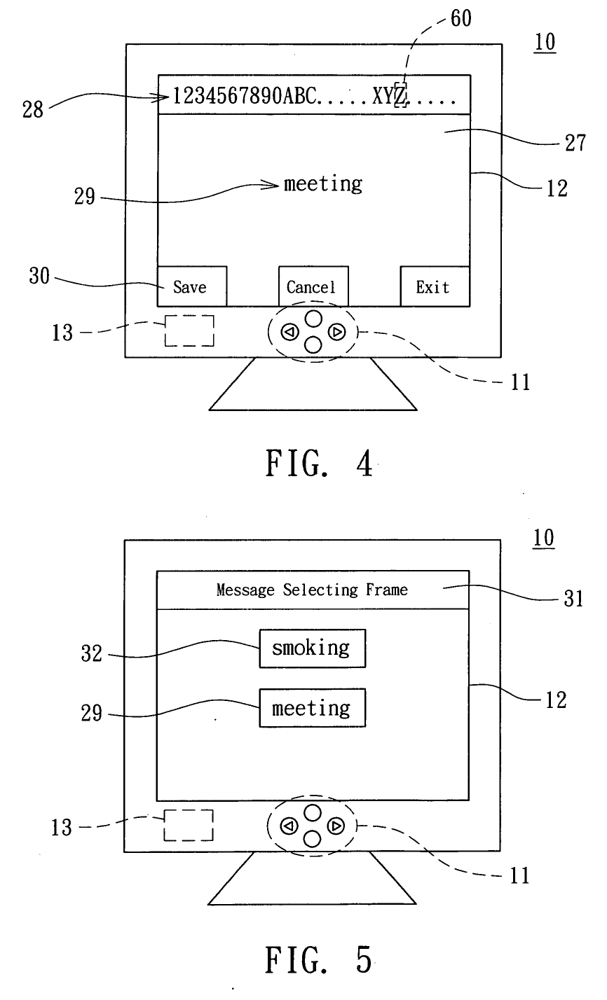

When the user selects the message board item 23 via the operating interface 11, the display unit 12 will display a message board window 24 as shown in FIG. 3. In FIG. 3, the message board window 24 at least includes a message editing item 25 and a message select item 26, wherein the message board window 24 further has a first cursor 50. The user can move the first cursor 50 to the message editing item 25 or the message select item 26 via operating interface 11 to select the message editing item 25 or the message select item 26. When the user uses the first cursor 50 to select the message editing item 25, the display unit 12 will display a message editing window 27 as shown in FIG. 4. In FIG. 4, the message editing window 27 has a plurality of characters 28; the user can use the operating interface 11 to select parts of the characters 28 to be edited as an input message 29 such as “meeting”. Next, the user can use the operating interface 11 to select the ‘save 30’ function item from the message editing window 27 for storing the input message 29 in the storage unit 13 to be selected from the message select item 26 in FIG. 3.

When the user uses the message editing window 27 to edit message, the message editing window 27 further has a second cursor 60, and the user can use the second cursor 60 to select any characters 28 from the operating interface 11. The characters 28 are arranged in a one-dimensional array, a two-dimensional array, or a gradient window. Also, the characters 28 can be any of the Arabic numerals, Chinese characters, English alphabets, punctuation marks, symbols, facial expressions, and combination thereof.

When the user does not want to edit message, the user can use message select item 26 to select a default message. When the user selects message select item 26, the display unit 12 will display a message selecting frame 31 as shown in FIG. 5. In FIG. 5, the message selecting frame 31 has at least a default message 32 such as “smoking”, and the default message 32 is pre-stored in the storage unit 13. When the user uses the above disclosed method to store the input message 29 in the storage unit 13 beforehand, the message selecting frame 31 further has the input message 29 such as “meeting”.

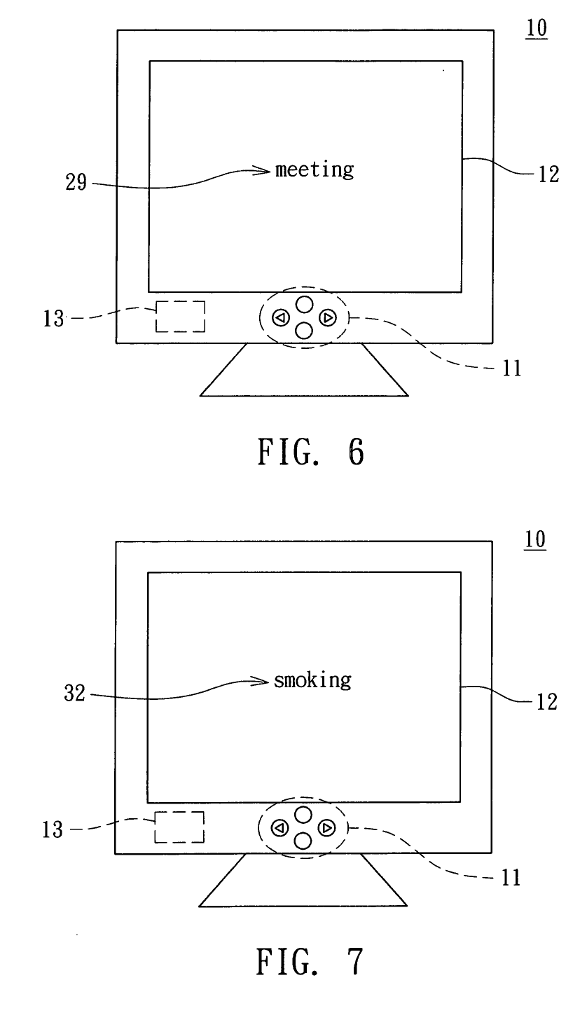

When the user uses the operating interface 11 to select the input message 29 in FIG. 5, the display unit 12 will display the input message 29 as shown in FIG. 6. After the input message 29 has been selected, the input message 29 on the frame of the display unit 12 may be displayed by ways of free movement, blinking, or scrolling. Also, when the user uses the operating interface 11 to select the default message 32, the display unit 12 will display a default message 32 as shown in FIG. 7. After the default message 32 has been selected, the default message 32 on the frame of the display unit 12 may be displayed by ways of free movement, blinking or scrolling.

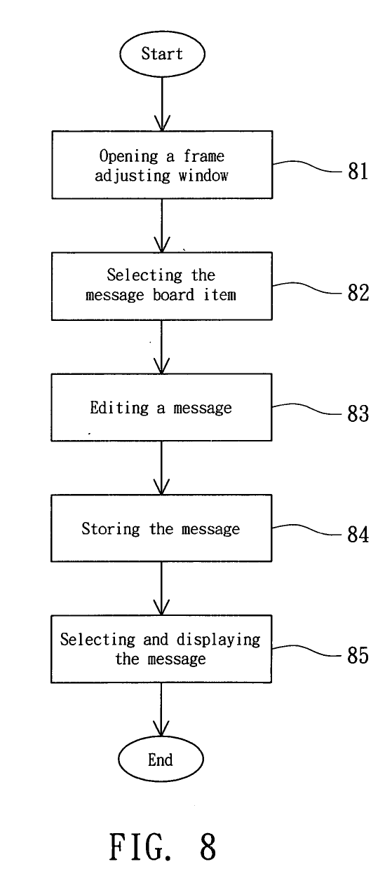

Referring to FIG. 8, a flowchart for a message displaying method according to a preferred embodiment of the invention is shown. Please refer to FIGS. 2˜6 again. Firstly, the method begins at step 81: open a frame adjusting window 21. The frame adjusting window 21 at least has a message board item 23 as shown in FIG. 2. Next, proceed to step 82: select the message board item 23 and accordingly display a message board window 24. The message board window 24 at least includes a message editing item 25 as shown in FIG. 3. After that, proceed to step 83: select a message editing item 25 and edit an input message 29 as shown in FIG. 4. Next, proceed to step 84: store the input message 29. After that, proceed to step 85: select and display the input message 29 as shown in FIGS. 5˜6.

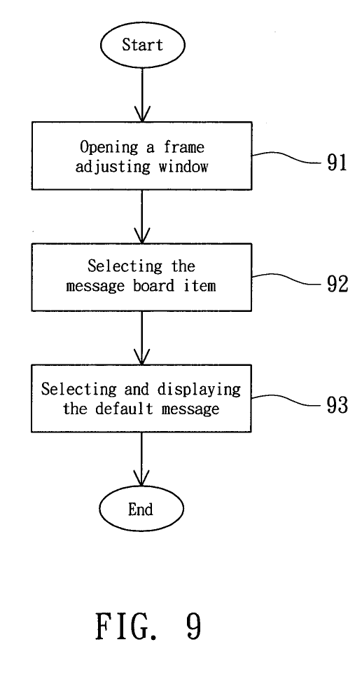

Referring to FIG. 9, a flowchart for a message displaying method according to another preferred embodiment of the invention is shown. Refer to FIGS. 2, 3, 5, and 7 again. Firstly, the method begins at step 91: open a frame adjusting window 21. The frame adjusting window 21 at least has a message board item 23 as shown in FIG. 2. Next, proceed to step 92: select the message board item 23 and accordingly display a message board window 24. The message board window 24 at least includes a default message 32 as shown in FIGS. 2˜3. After that, proceed to step 93: select and display the default message 32 as shown in FIGS. 5, 7.

However, anyone who is familiar with the technology will understand that the technology of the invention is not limited thereto. For example, the display unit 12 can be a liquid crystal display panel (LCD panel) or an organic light emitting diode (OLED) display panel. Also, the storage unit 13 is a memory.

In the OSD device and message displaying method disclosed in the above preferred embodiments of the invention, the extra design of having a message board item allows the user to edit and select a message and have the selected message displayed on the OSD device, enabling the OSD device to use a screen protection routine to display message even when the computer is switched off and greatly enhancing the practicality of the OSD device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An on screen display (OSD) device, comprising:
an operating interface;
a display unit for displaying a frame adjusting window comprising a message board item when the operating interface is pressed and for displaying a message board window comprising a message editing item for editing a message when the message board item is selected via the operating interface; and
a storage unit for storing the message;
wherein the message is displayed when the message is selected via the operating interface.

2. The device according to claim 1, wherein the display unit displays a message editing window when the message editing item is selected via operating interface, and the message editing window has a plurality of characters, parts of the characters are selected via the operating interface and are edited to form the message.

3. The device according to claim 2, wherein the message board window has a cursor, for being moved to the message editing item via the operating interface.

4. The device according to claim 2, wherein the message editing window has a cursor, for being moved to any of the characters via the operating interface.

5. The device according to claim 2, wherein the characters are arranged in a one-dimensional array, a two-dimensional array, or a gradient window.

6. The device according to claim 2, wherein the characters are selected from the group consisting of a plurality of Arabic numerals, a plurality of Chinese characters, a plurality of English alphabets, a plurality of punctuation marks, a plurality of symbols, a plurality of facial expressions, and combination thereof.

7. The device according to claim 1, wherein the selected message is displayed on a display frame of the display unit by ways of free movement, blinking, or scrolling.

8. The device according to claim 1, wherein the message board window further comprises at least a default message, which is stored in the storage unit, and the default message is displayed on the display unit when selected via the operating interface.

9. The device according to claim 8, wherein the default message is displayed on a display frame of the display unit by ways of free movement, blinking or scrolling after having been selected.

10. The device according to claim 1, wherein the operating interface comprises a function key, a select key, and a direction key.

11. An on screen display (OSD) device, comprising:
an operating interface;
a display unit for displaying a frame adjusting window comprising a message board item when the operating interface is pressed and for displaying a message board window comprising at least a default message when the message board item is selected via the operating interface; and
a storage unit for storing the default message;
wherein the display unit displays the default message when the default message is selected via operating interface.

12. The device according to claim 11, wherein the message board window comprises a cursor, for being moved to the default message via the operating interface.

13. The device according to claim 11, wherein the default message is displayed on a display frame of the display unit by ways of free movement, blinking, or scrolling after having been selected.

14. The device according to claim 11, wherein the operating interface comprises a function key, a select key, and a direction key.

15. A message displaying method, comprising:
opening a frame adjusting window comprising a message board item;
selecting the message board item to accordingly display a message board window comprising a message editing item;
selecting the message editing item to edit a message;
storing the message; and
selecting and displaying the message.

16. The method according to claim 15, wherein the step of editing the message further comprises:
selecting the message editing item to accordingly display a message editing window comprising a plurality of characters; and
selecting and editing parts of the characters to form the message.

17. The method according to claim 16, wherein the step of selecting and displaying the message further comprises:
selecting and displaying the message on a display frame by ways of free movement, blinking, or scrolling.

18. A message displaying method, comprising:
opening a frame adjusting window comprising a message board item;
selecting the message board item and accordingly display a message board window at least comprising a default message; and
selecting and displaying the default message.

19. The method according to claim 18, wherein the step of selecting and displaying the default message further comprises:
selecting and displaying the default message on a display frame by ways of free movement, blinking, or scrolling.
